(19) United States
(12) Patent Application Publication
(10) Pub. No.: US 2018/0051834 A1
(43) Pub. Date: Feb. 22, 2018

(54) Pressing Sleeve, Press Fitting and Use of the Press Fitting or the Pressing Sleeve

(71) Applicant: Viega Technology GmbH & Co. KG, Attendorn (DE)

(72) Inventor: Frank Hofmann, Attendorn (DE)

(21) Appl. No.: 15/555,222

(22) PCT Filed: Feb. 17, 2016
(86) PCT No.: PCT/EP2016/053362

§ 371 Date: Sep. 1, 2017

(30) Foreign Application Priority Data
Mar. 5, 2015 (DE) 10 2015 103 228.7

(51) Int. Cl. F16L 13/14; B21D 39/04

(52) U.S. Cl. CPC F16L 13/146; B21D 39/046

(57) ABSTRACT

The invention relates to a press sleeve for a press fitting for producing a sealing non-detachable pipe connection, with a receiving portion (4) for receiving a fitting basic body (6) and with a press portion (8), wherein the inside diameter of the receiving portion (4) is adapted to the outside diameter of the fitting basic body (6) and wherein the inside diameter of the press portion (8) is designed to be smaller than the outside diameter of the fitting basic body (6) at least in certain sections. The press sleeve is distinguished by the fact that at least one retaining lug (10) which can be clamped resiliently inwards in the radial direction (R) is provided in the receiving portion (4) and that the retaining lug (10) has a free end portion (12) which, with the retaining lug (10) in the stress-relieved state, protrudes at least partially into the inner region of the receiving portion (4) in the radial direction (R).

The invention relates to a pressing sleeve for a press fitting for producing a sealing, non-releasable pipe connection, having a receiving section for receiving a main fitting body and having a pressing section, wherein the inner diameter of the receiving section is adapted to the outer diameter of the main fitting body, and wherein the inner diameter of the pressing section is at least in sections designed to be smaller than the outer diameter of the main fitting body. The invention further relates to a press fitting having a pressing sleeve according to the invention and to the use of a pressing sleeve according to the invention or of a press fitting according to the invention.

Pressing sleeves of the type mentioned at the outset are usually used in pipeline systems in order, in conjunction with a main fitting body, to connect pipes together in a metallically sealing and non-releasable manner. A generic pressing sleeve is known from WO 2014/000897 A1, for example.

According to WO 2014/000897 A1, in order to produce a metallically sealing non-releasable pipe connection firstly a pipe end of the pipe to be connected is inserted into an opening of the main fitting body, so that the main fitting body circumferentially encloses the pipe end. The pressing sleeve is pushed onto the main fitting body in the axial direction by means of a pressing tool, wherein “the axial direction” is oriented along the longitudinal axis of the pipe end and hence transverse to the pipe cross-section. The diameter of the inner lateral surface of the pressing sleeve is tapered over the length of the pressing sleeve measured in the axial direction, so that when the pressing sleeve is pushed on axially, the periphery or the peripheral region of the main fitting body is flanged and pressed into the pipe end to be connected. In other words, the periphery or peripheral region of the main fitting body is radially narrowed in its diameter. Therefore, pushing the pressing sleeve on axially is translated into a radial deformation of the main fitting body by means of the preferably tapered lateral surface provided on the pressing sleeve. The “radial direction” is oriented transverse to the longitudinal extension of the pipe end to be connected and hence transverse to the axial direction. In this way, the main fitting body and the pipe end are plastically deformed and pressed together by pushing the pressing sleeve on axially.

In the case of the fittings known from WO 2014/000897 A1 it can occasionally happen that the pre-installed pressing sleeve slips off again from the main fitting body before pressing takes place. Furthermore, in some circumstances, with bending or tensile loads leaks can occur at the pressed connection.

Against this background, the present invention is based on the technical problem of specifying a pressing sleeve, a press fitting having such a pressing sleeve and the use of such a pressing sleeve or of such a press fitting which do not have or at least only to a lesser extent have the previously mentioned disadvantages and in particular enable a robust, sealing pipe connection to be produced in a simple and cost-effective way.

This technical problem is solved according to the invention by a pressing sleeve according to claim 1, by a press fitting having such a pressing sleeve according to claim 13 and by the use of the pressing sleeve and of the press fitting according to claim 14.

The pressing sleeve is characterised in that at least one retaining lug which can be clamped resiliently elastically inwards in the radial direction is provided in the receiving section, and in that the retaining lug has a free end section which, with the retaining lug in the unclamped state, protrudes in the radial direction at least partially into the interior of the receiving section.

The pressing sleeve is secured against axial displacement in the installed state by means of the retaining lug. The pressing sleeve is clamped with the main fitting body in the radial direction by the retaining lug, wherein the friction between the pressing sleeve and the main fitting body counteracting an axial loosening of the pressing sleeve is increased by means of the radial clamping forces. Additionally or alternatively, in the installed state there is a form-fit connection between the pressing sleeve and the main fitting body counteracting axial loosening. Such a form-fit connection can be formed by the retaining lug penetrating into the material of the main fitting body in a direction turned radially inwards or elastically and/or plastically deforming the main fitting body. Alternatively or additionally, such a form-fit connection can be formed by the retaining lug engaging, in particular in the manner of a snap connection, with a recess, such as a narrow channel, a groove profile or suchlike, formed circumferentially on the main fitting body. The form-fit connection between the retaining lug and the main fitting body can be formed in the area of the free end section of the retaining lug.

Axial securing of the pressing sleeve on the main fitting body by means of the at least one retaining lug can already take effect in a pre-installed state of the pressing sleeve, in which the main fitting body in the pre-installed state is received in the receiving section of the pressing sleeve, while the periphery or peripheral region of the main fitting body in the pre-installed state is still not flanged. In other words, the receiving section can circumferentially receive the periphery or peripheral region of the main fitting body to be pressed in the pre-installed state, while the pressing section is arranged adjacent to the periphery or peripheral region of the main fitting body in the axial direction.

The interior of the receiving section can be a for example essentially cylindrical opening which is adapted to the outer diameter of the main fitting body. “Adapted” in this context means that a suitable press fit, transition fit or clearance fit can be formed between the receiving section and the main fitting body, which enables a reliable (pre-) installation of the pressing sleeve and the main fitting body to be effected for the respective application. The main fitting body can be an essentially cylindrical sleeve.

Preferably, the pressing sleeve can be produced by forming, in particular by deep drawing. Consequently, cost-effective and material-saving forming, in particular sheet metal forming, can be reverted to for producing the pressing sleeve, since the retaining lug counteracts the tendency described at the outset of pressing sleeves produced by forming to slip off from the main fitting body after joining has taken place. The pressing sleeve can be produced as one piece from a metal sheet by deep drawing.

In order to strengthen or reinforce the pressing section, the periphery or peripheral region of the pressing section facing away from the receiving section can be flanged outwards. The flanged periphery or peripheral region of the pressing section can, for example, take the shape of an essentially annular, circularly circumferential collar.

The retaining lug can be released through a radial opening provided between an inner lateral surface and an outer lateral surface of the pressing sleeve. The opening can, for example, be produced by punching and/or machining. After releasing the retaining lug or producing the opening, the retaining lug can be bent radially inwards, so that the free end section of the retaining lug at least partly engages with the interior of the receiving section. The material thickness or wall thickness of the retaining lug preferably corresponds to the material thickness or wall thickness of the pressing sleeve, wherein the pressing sleeve and the retaining lug are in particular formed as one piece. The retaining lug can be manufactured together with the pressing sleeve or as an integral component of the pressing sleeve from one metal sheet cost-effectively.

According to one embodiment, the pressing sleeve in the area of the receiving section has a face side provided for inserting the main fitting body. According to this embodiment, the retaining lug is inclined in the direction facing away from the face side. In other words, the retaining lug is in particular inclined in the manner of an installation bevel against the face side provided for inserting the main fitting body. The insertion of the main fitting body is made easier by the orientation of the retaining lug. In particular, the retaining lug can be provided on the face side in the area of the receiving section. The face-side retaining lug can be produced by punching and/or machining a metal sheet or a sleeve with subsequent deep drawing and/or flanging of the face-side peripheral area of the receiving section of the pressing sleeve.

In particular, a guide surface of the retaining lug facing the face side can be arranged inclined at an angle in relation to a central axis of the pressing sleeve, wherein the angle is greater than 0° and less than 90°. In other words, the guide surface can be set at an acute angle relative to a central axis of the pressing sleeve. When inserting the main fitting body, the guide surface can serve to translate the axial relative movement between the pressing sleeve and the main fitting body into a clamping of the retaining lug against the main fitting body. The guide surface preferably slides along a face side of the main fitting body or along the periphery of the main fitting body delimiting the outer lateral surface of the main fitting body on the face side, is as a result displaced by the main fitting body circumferentially in the radial direction outwards and in this way is clamped resiliently elastically inwards against the main fitting body. This effect can be achieved both when the pressing sleeve is pre-installed on the main fitting body and, alternatively or additionally, when pressing the pressing sleeve, the main fitting body and a pipe to be connected.

A pressing edge provided for abutting on the main fitting body is formed in the area of the free end section of the at least one retaining lug, wherein the pressing edge is in particular sharp-edged. The term “sharp-edged” in the present case means a pressing edge which forms an angle of less than or equal to 90°. The smaller the angle is, the more sharp-edged the pressing edge is. The clamping effect of the retaining lug counteracting an axial displacement of the pressing sleeve in the installed state can be increased by means of the pressing edge. The pressing edge is preferably formed to circumferentially penetrate into the material of the main fitting body. The retaining lug can claw into the material of the main fitting body in a form-fit manner by means of the pressing edge. The free end section of the retaining lug provided with the pressing edge can counteract in a form-fit manner an axial displacement between the pressing sleeve and the main fitting body in a pre-installed and/or in an installed state of the pressing sleeve.

Particularly in the case where the retaining lug is extended in the direction facing away from the face side of the pressing sleeve provided for inserting the pressing sleeve, the retaining lug provided with a pressing edge can prevent the pressing sleeve from axially slipping off from the main fitting body in the manner of a barbed hook or a claw. On the one hand, the pressing sleeve can be axially pushed onto the main fitting body in the installation direction or pressing direction, while, on the other hand, subsequent removal of the pressing sleeve counter to the installation direction is inhibited or blocked by the retaining lug, so that removal of the pressing sleeve from the main fitting body is not possible without destroying it.

The receiving section of the pressing sleeve can have an essentially constant opening width along its length measured in the axial direction. Here, an “essentially constant opening width” means that the opening width of the receiving section is at least in sections locally narrowed in the area of one or more retaining lugs extended radially inwards. The receiving section can serve for pre-installing and guiding the main fitting body to be pressed with the pressing sleeve and simplify the installation process or pressing process.

The inner contour of the receiving section can alternatively also in an axial longitudinal section at least in sections be designed tapered in a conical and/or curved manner and/or linearly. This inner contour can at least in sections be interrupted by the at least one retaining lug. The at least one retaining lug can extend, in particular starting from the inner contour of the receiving section, at least in sections in a direction turned radially inwards.

The at least one retaining lug can in particular be designed in such a way that the retaining lug in the unclamped state at least in sections defines the clear width of the receiving section. The at least one retaining lug can with an inner lateral surface of the receiving section and/or of one or more further retaining lugs delimit an opening, the diameter or clear width of which is less than the outer diameter of the main fitting body. The pressing sleeve can be designed in such a way that the free end section of the retaining lug, when the pressing sleeve is pushed onto the main fitting body, is displaced outwards in the radial direction by the outer lateral surface of the main fitting body and in this way clamped against the main fitting body. The clamping of the retaining lug can occur automatically when the pressing sleeve is axially pushed onto the main fitting body, without an additional production step being required. Thus, the pressing sleeve can be joined and clamped using a pressing tool known from WO 2014/000897 A1, for example.

The pressing section extended in the direction facing away from the face side can be attached to the receiving section, wherein the inner diameter of the pressing section is tapered in the direction facing away from the face side. The receiving section and the pressing section, in particular their inner contours, can merge directly into one another, in particular without discontinuity, i.e. e.g. tangentially continuous or curvature continuous. After a main fitting body has been pre-installed, the pressing sleeve can be pushed directly onto the main fitting body in the axial direction. Thus, in a simple way, a pressing process which in particular is as smooth as possible can take place.

An end section extended in the direction facing away from the face side can be attached to the pressing section, wherein the pressing sleeve in particular has an essentially constant opening width in the area of the end section. The contact or pressing surface formed between the pressing sleeve and the main fitting body can be increased by means of the end area, in order to further improve the axial fixing of the pressing sleeve on the main fitting body. In alternative embodiments, the end section can be flanged outwards to reinforce the pressing section and, for example, take the shape of an in particular essentially circularly circumferential collar.

The receiving section on the face side can merge into a circularly circumferential flange. Thus, the pressing sleeve can, for example, be formed like a funnel in the area of this face side, in order to make the insertion of a main fitting body easier. The retaining lugs starting from the flange can at least in sections be extended in a direction turned radially inwards.

According to one embodiment of the pressing sleeve, at least two, in particular at least three, retaining lugs can be provided. Axial securing is strengthened in this way.

The retaining lugs can be arranged at regular angular distances in relation to one another. Tilting of the pressing sleeve when pushing it onto the main fitting body is thereby prevented by an essentially symmetrical guidance formed by the retaining lugs.

The retaining lugs are in particular formed as separate elements. As a result, the retaining lugs can be manufactured from a different material than the rest of the pressing sleeve, in particular the pressing section. The function of the retaining lugs can be further optimised by means of a suitable choice of material, for example a particularly elastic material can be used. If a pressing edge is provided on the retaining lugs, a particularly hard material can also be used. Forming the retaining lugs as separate elements also simplifies the production of the pressing sleeve, as the retaining lugs can also be produced separately and subsequently inserted into the pressing sleeve. In particular, to make production of the pressing sleeve simple, the retaining lugs can be provided in the form of a separate cutting ring. Such a cutting ring with retaining lugs can be inserted into a groove in the pressing sleeve in a form-fit manner.

The invention further relates to a press fitting for a sealing, non-releasable pipe connection, having a main fitting body for accommodating at least one pipe to be connected and having a pressing sleeve according to the invention. The main fitting body can be an essentially rotationally symmetrical, in particular cylindrical, component, like e.g. a sleeve or a pipe section. The at least one retaining lug improves in particular the axial hold of the pressing sleeve on an outer lateral surface of the main fitting body which is essentially smooth, in particular free of grooves and/or recesses. Alternatively or additionally, one or more recesses formed circumferentially on the main fitting body, such as a narrow channel, a groove profile or suchlike, can be provided, with which the retaining lug engages, in particular in the manner of a snap connection.

The press fitting and the pressing sleeve are, for example, provided for connecting pipes having a circular cross-section.

The pressing sleeve and/or the main fitting body can, for example, be formed from a steel material, in particular a high-grade steel material, or a copper material, in particular brass, or an aluminium material. Preferably, the material of the pressing sleeve can have a higher hardness than the material of the main fitting body. As a result, this helps the free end section of the retaining lug to penetrate into the material of the main fitting body and hence helps the axial fixing of the pressing sleeve on the main fitting body.

The invention also relates to the use of a pressing sleeve or of a press fitting according to any one of the preceding claims in a heating installation, air-conditioning installation, sanitary installation or drinking water installation or in an installation for conveying technical or medical fluids. Thus, for example, by the use of the pressing sleeve or press fitting, in a simple and reliable way a metallically sealing connection between two pipe ends can be produced in the above mentioned application areas.

The invention is explained in more detail below by means of exemplary embodiments.

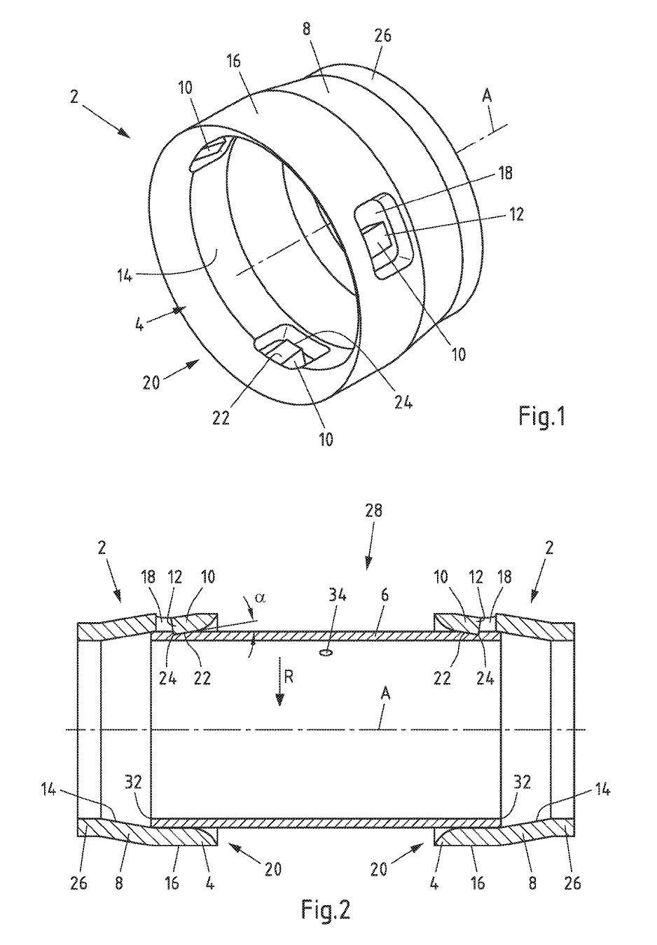

FIG. 1 shows a first pressing sleeve in a perspective view,

FIG. 2 shows two pressing sleeves according to FIG. 1 in a pre-installed state on a main fitting body,

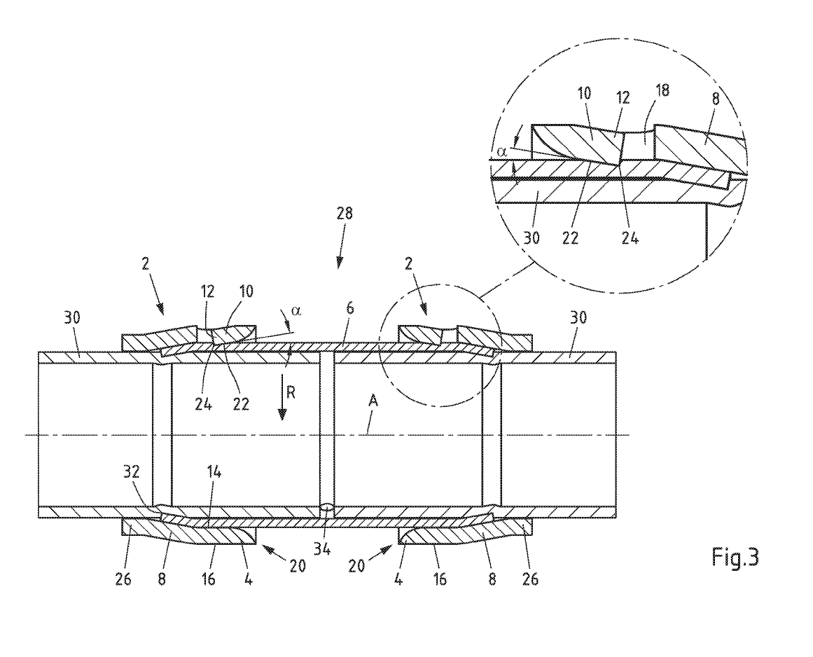

FIG. 3 shows two pressing sleeves according to FIG. 1 in an installed state on a main fitting body with two pipe ends,

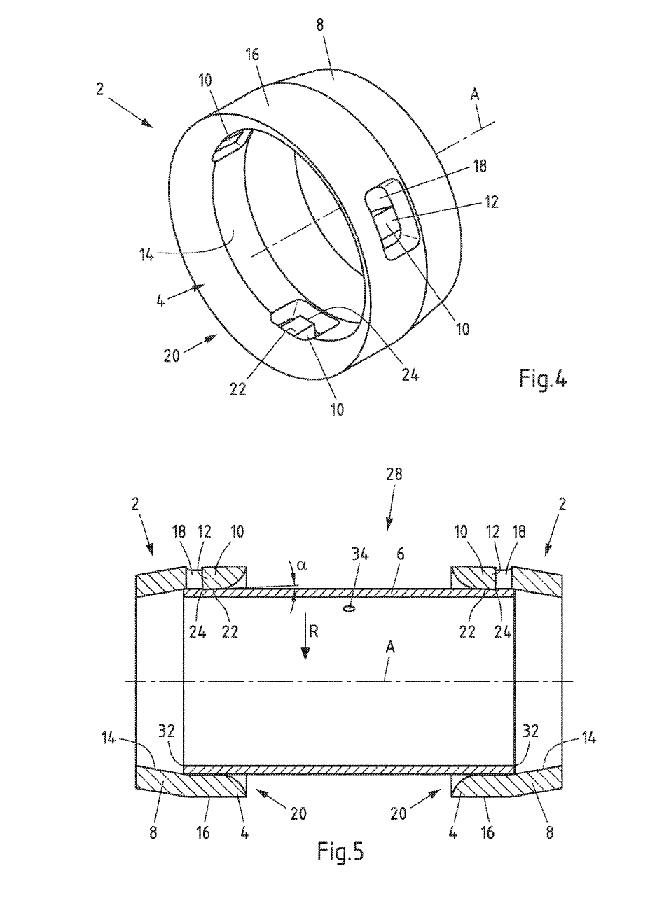

FIG. 4 shows a second pressing sleeve in a perspective view,

FIG. 5 shows two pressing sleeves according to FIG. 4 in a pre-installed state on a main fitting body,

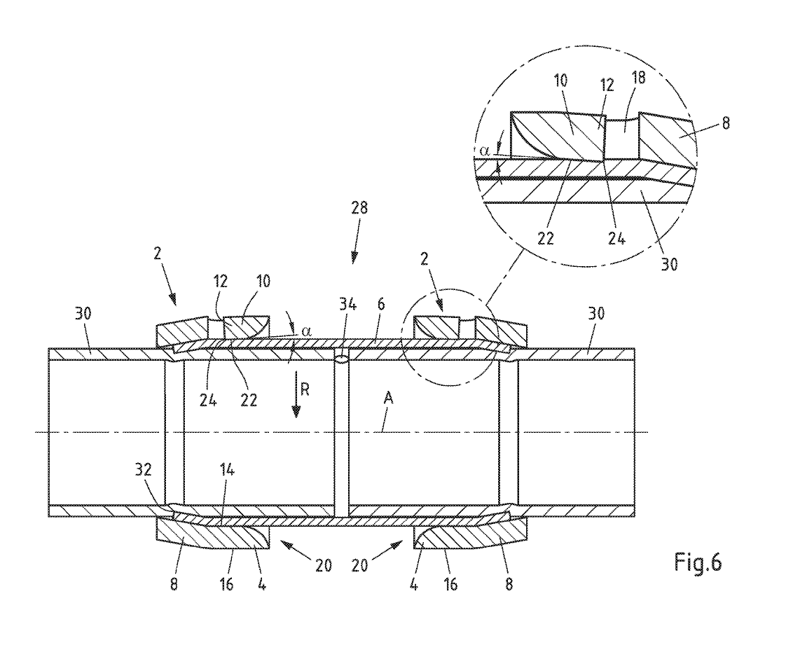

FIG. 6 shows two pressing sleeves according to FIG. 4 in an installed state on a main fitting body with two pipe ends,

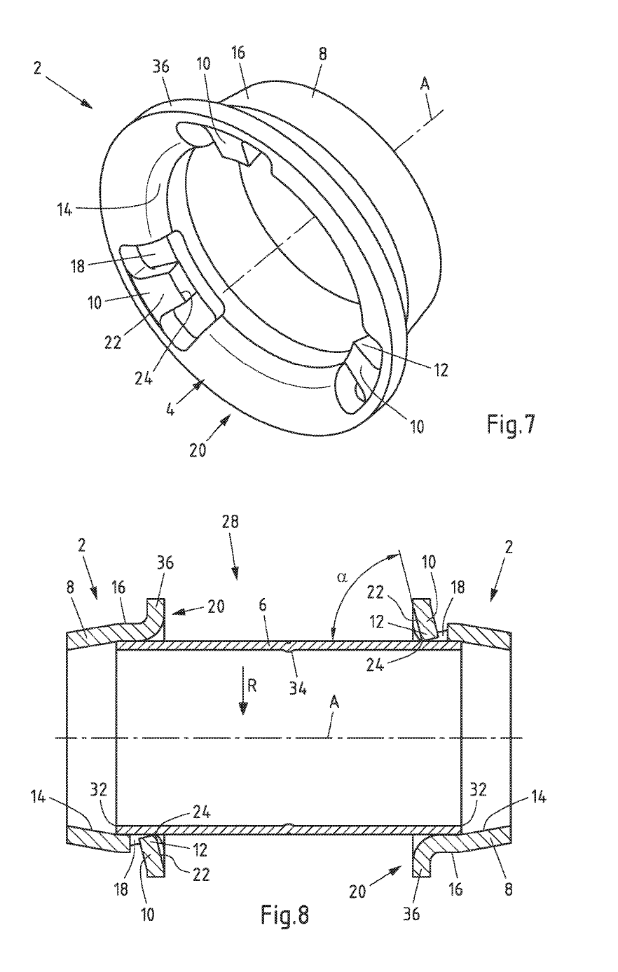

FIG. 7 shows a third pressing sleeve in a perspective view,

FIG. 8 shows two pressing sleeves according to FIG. 7 in a pre-installed state on a main fitting body,

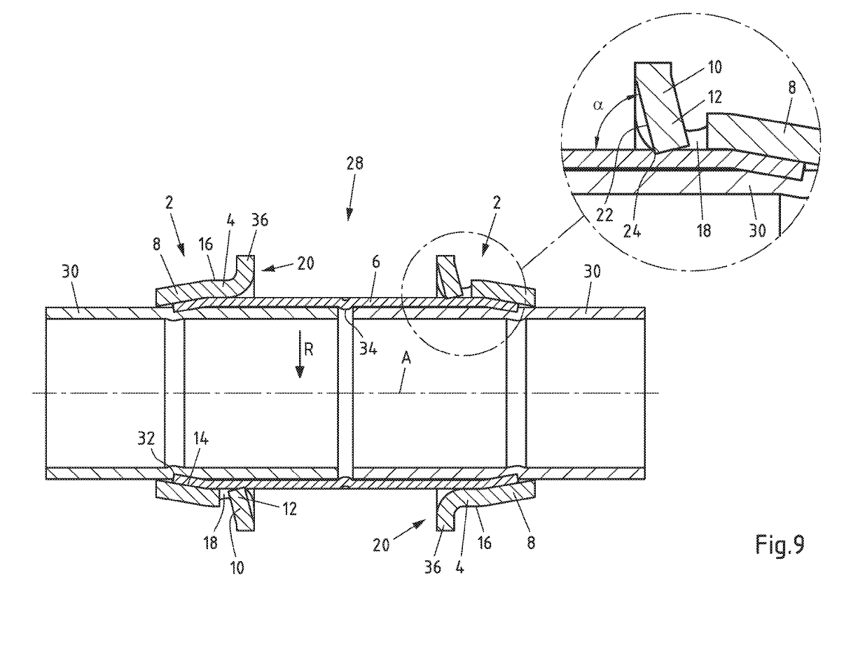

FIG. 9 shows two pressing sleeves according to FIG. 7 in an installed state on a main fitting body with two pipe ends,

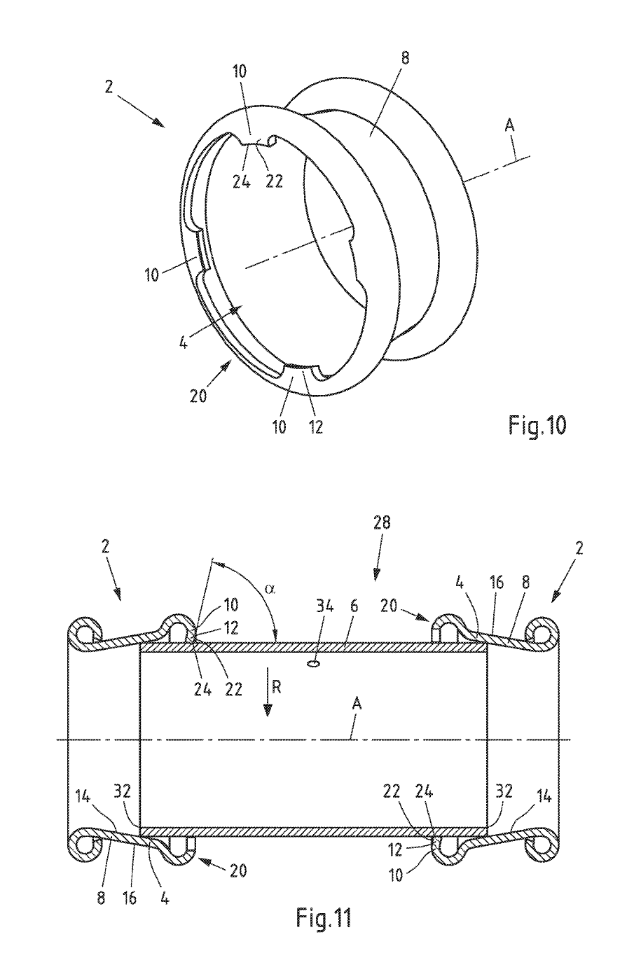

FIG. 10 shows a fourth pressing sleeve in a perspective view,

FIG. 11 shows two pressing sleeves according to FIG. 10 in a pre-installed state on a main fitting body,

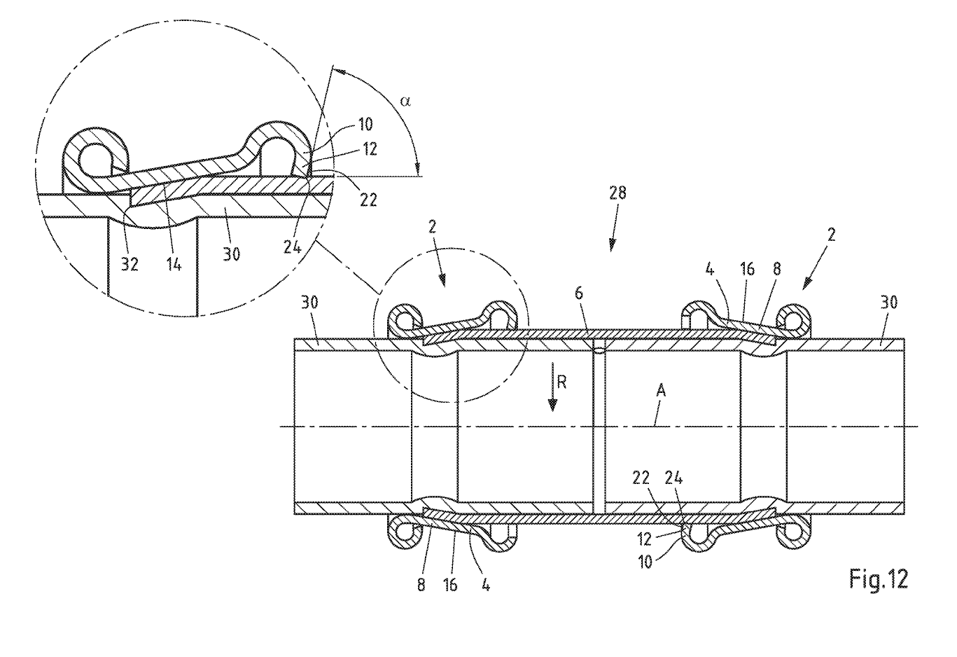

FIG. 12 shows two pressing sleeves according to FIG. 10 in an installed state on a main fitting body with two pipe ends,

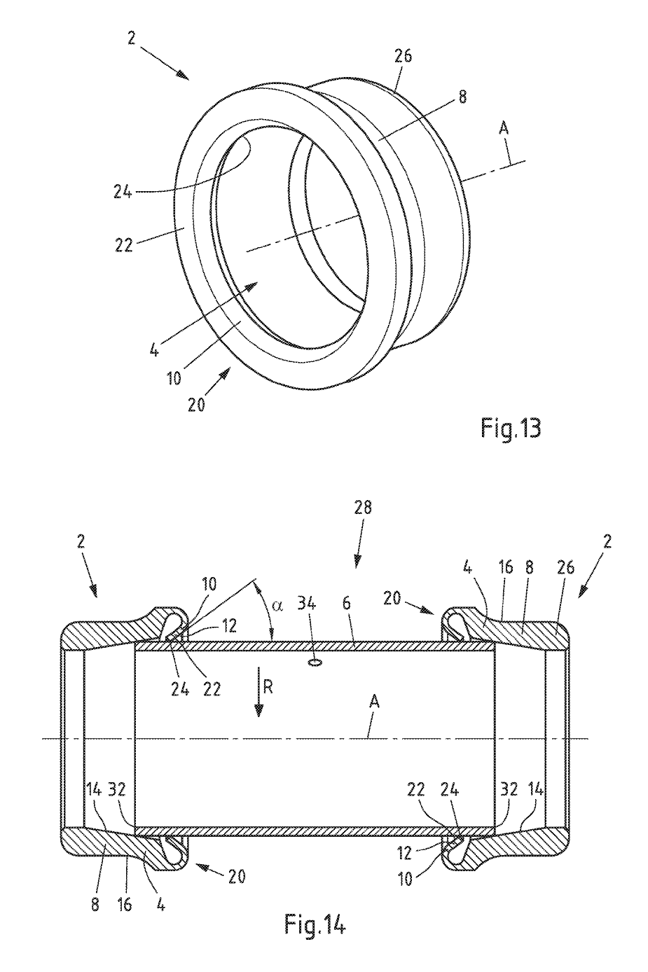

FIG. 13 shows a fifth pressing sleeve in a perspective view,

FIG. 14 shows two pressing sleeves according to FIG. 13 in a pre-installed state on a main fitting body,

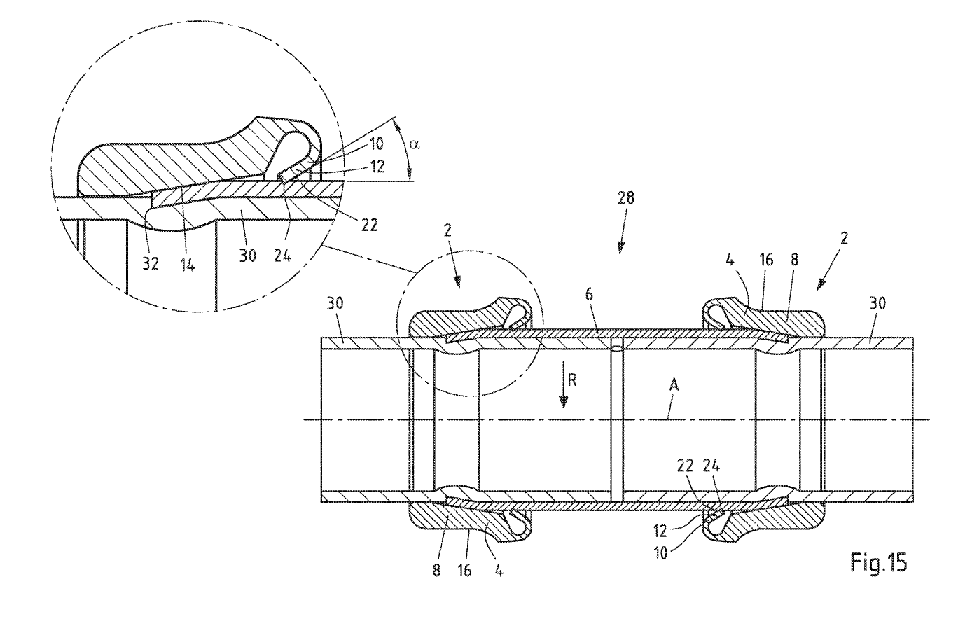

FIG. 15 shows two pressing sleeves according to FIG. 13 in an installed state on a main fitting body with two pipe ends,

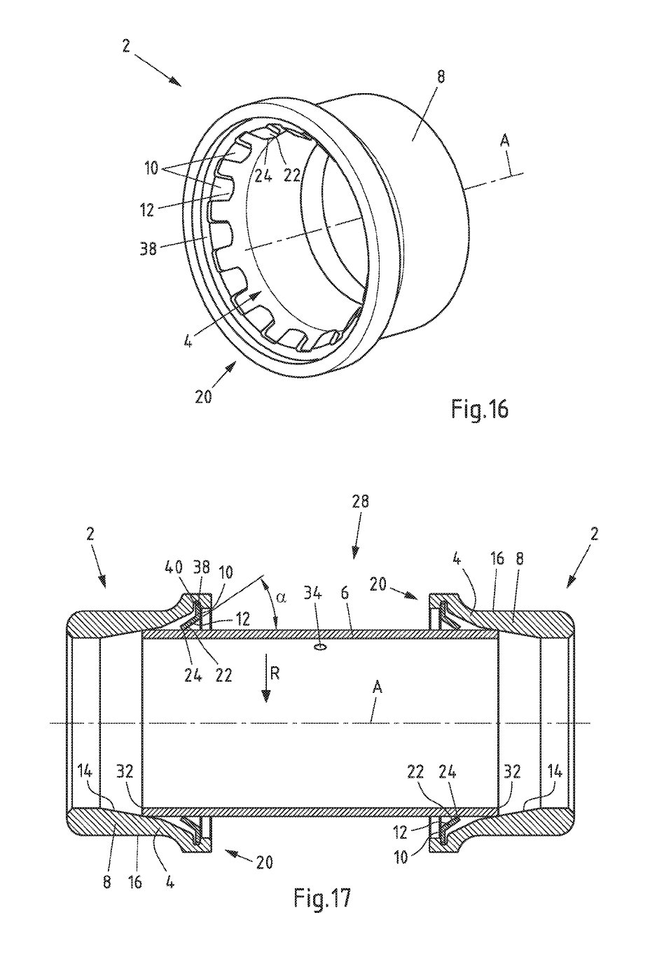

FIG. 16 shows a sixth pressing sleeve in a perspective view,

FIG. 17 shows two pressing sleeves according to FIG. 16 in a pre-installed state on a main fitting body,

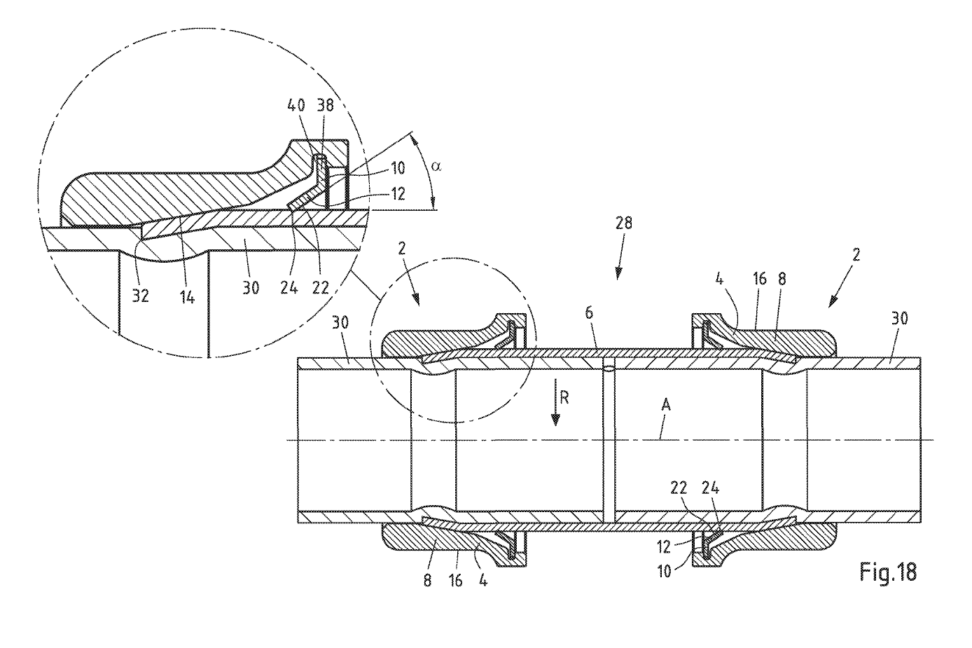

FIG. 18 shows two pressing sleeves according to FIG. 16 in an installed state on a main fitting body with two pipe ends.

FIG. 1 shows a first pressing sleeve 2 in a perspective view. The pressing sleeve 2 for a press fitting for producing a sealing, non-releasable pipe connection has a receiving section 4 for receiving a main fitting body 6 to be pressed radially (see FIG. 2). The pressing sleeve 2 has a pressing section 8 which is designed for radially narrowing the main fitting body 6 and is tapered viewed along an axis A. The inner diameter of the receiving section 4 is adapted to the outer diameter of the main fitting body 6. The inner diameter of the pressing section 8 is at least in sections smaller than the outer diameter of the main fitting body 6.

The pressing sleeve 2 has three retaining lugs 10 which can be clamped resiliently elastically in the radial direction against the main fitting body 6. The retaining lugs 10 each have a free end section 12. In the unclamped state (FIG. 1) of the retaining lugs 10, the respective end section 12 protrudes in the radial direction R at least partially into the interior of the receiving section 4.

The pressing sleeve 2 is produced from a metal sheet by deep drawing. The retaining lugs 10 are released through radial openings 18 provided between an inner lateral surface 14 and an outer lateral surface 16 of the pressing sleeve 2. The openings 18 are produced by punching. The retaining lugs 10 were bent inwards in the radial direction R after punching had taken place, so that the respective free end section 12 of a retaining lug 10 in the unclamped state (FIG. 1) protrudes at least partially into the interior of the receiving section 4.

The pressing sleeve 2 has a face side 20 provided for inserting the main fitting body 6. The retaining lugs 10 are inclined in the direction facing away from the face side 20. A guide surface 22 of the respective retaining lug 10 facing the face side 20 is inclined at an acute angle a in relation to the axis A (see FIG. 2).

The retaining lug 10 has a rectangular, i.e. sharp-edged, pressing edge 24 in the area of its free end section 12 and is provided for abutting on the main fitting body 6.

The receiving section 4 of the pressing sleeve 2 is assigned to the face side 20 provided for inserting the main fitting body 6. The receiving section 4 has an essentially constant opening width along its length measured in the axial direction. The pressing section 8 extending in the direction facing away from the face side 20 is attached to the receiving section 4. The pressing section 8 is tapered in the direction facing away from the face side 20. An end section 26 extending in the direction facing away from the face side 20 is attached to the pressing section 8, in which the pressing sleeve 2 has an essentially constant opening width. The retaining lugs 10 are provided in the receiving section 4. The retaining lugs 10 are arranged at regular angular distances in relation to one another.

FIG. 2 shows two pressing sleeves 2 according to FIG. 1 and the main fitting body 6, which is to be pressed by means of the pressing sleeves 2, in a pre-installed state. The pressing sleeves 2 and the main fitting body 6 form a press fitting 28 for connecting two pipe ends 30 (see FIG. 3). The pipe ends 30 can each be inserted into the main fitting body 6. The pipe ends 30 are pressed with the main fitting body 6 by flanging the periphery 32 of the main fitting body 6. To that end, the pressing sleeves 2, starting from the pre-installation position illustrated in FIG. 2, are pushed onto the main fitting body 6 in the axial direction along the axis A.

FIG. 3 shows the press fitting 28 with the pipe ends 30 in the installed, pressed state. The pipe ends 30 are each inserted into the main fitting body 6 up to a stop 34 provided in the area of the inner lateral surface of the main fitting body 6. It can be identified from the enlarged illustration how the pressing sleeve 2, the main fitting body 6 and the pipe end 30 interact in each case.

When the press fitting 28 is pressed with a respective pipe end 30, the pressing sleeve 2 is pushed onto the main fitting body 6 in the axial direction. A pressing tool, which is not illustrated here and is known, for example, from WO 2014/000897 A1, is used for this purpose. During the axial movement, the peripheral area or the periphery 32 of the main fitting body 6 slides along the pressing section 8 of the pressing sleeve 2 narrowing in diameter. The peripheral area or the periphery 32 of the main fitting body 6 is flanged in a direction turned radially inwards. In other words, the pressing sleeve 2 forms a matrix, wherein the peripheral area or the periphery 32 of the main fitting body 6 abuts tightly on the tapered pressing section 8 of the pressing sleeve 2 during the pressing process, so that the peripheral area or the periphery 32 of the main fitting body 6 slides along the inner contour of the pressing section 8 and is thereby plastically deformed. The shape of the pressing sleeve 2 remains essentially unchanged.

The retaining lugs 10 engage with the material of the main fitting body 6 with their pressing edges 24 and prevent the respective pressing sleeve 2 from axially slipping off from the main fitting body 6. The material of the pressing sleeve 2 is harder than the material of the main fitting body 6. After it has been axially pushed onto the main fitting body 6, the respective pressing sleeve 2 can no longer be removed from the main fitting body 6 without destroying it, since the retaining lugs 10 grip tightly with the free end sections 12 in the main fitting body 6.

Further exemplary embodiments of pressing sleeves are described below, wherein in comparison with the previously exemplary embodiment identical reference symbols are assigned to components or structural features having essentially the same effect.

FIG. 4 shows a second exemplary embodiment of a pressing sleeve 2 in a perspective view. The pressing sleeve 2 illustrated in FIG. 3 only differs from the exemplary embodiment described in FIG. 1 in that the end section has been dispensed with.

FIG. 5 shows two pressing sleeves 2 according to FIG. 4 and a main fitting body 6 in a pre-installed state. As with the first exemplary embodiment, the retaining lugs 10 already secure the pressing sleeves 2 in the pre-installed state from being axially pulled off or slipping off from the main fitting body 6 counter to the installation direction or joining direction.

FIG. 6 shows two pressing sleeves 2 according to FIG. 4 in an installed state on the main fitting body 6 with two pipe ends 30. Again, the interaction of the pressing sleeve 2, the main fitting body 6 and the pipe end 30 can be understood from the detail.

FIG. 7 shows a third exemplary embodiment of a pressing sleeve 2 in a perspective view which differs from the exemplary embodiment described in FIG. 1 in that an end section has been dispensed with and in that the receiving section 4 on the face side merges into a circularly circumferential flange 36. The retaining lugs 10 are arranged in the area of the flange 36. The retaining lugs 10 are set at an essentially steeper angle a with respect to the axis A compared to the previously described exemplary embodiments. In this way, a particularly narrow design of the pressing sleeve 2 in the axial direction is obtained.

FIG. 8 shows two pressing sleeves 2 according to FIG. 7 and a main fitting body 6 in a pre-installed state. As with the previously described exemplary embodiments, the retaining lugs 10 already secure the pressing sleeves 2 in the pre-installed state from being axially pulled off or slipping off from the main fitting body 6 counter to the installation direction or joining direction.

FIG. 9 shows two pressing sleeves according to FIG. 7 in an installed state on the main fitting body 6 with two pipe ends 30. The interaction of the pressing sleeve 2, the main fitting body 6 and the pipe end 30 can be understood from the detail.

FIG. 10 shows a fourth exemplary embodiment of a pressing sleeve 2 in a perspective view. The pressing sleeve 2 shown in FIG. 10 is characterised by the fact that the retaining lugs 10 are provided directly on the face side on the receiving section 4. Both the periphery of the receiving section and the periphery of the pressing section are flanged in a circular or curved manner. In this way, the pressing sleeve 2 is strengthened or reinforced against radial widening during the pressing process.

FIG. 11 shows two pressing sleeves 2 according to FIG. 10 and a main fitting body 6 in a pre-installed state. As with the previously described exemplary embodiments, the retaining lugs 10 already secure the pressing sleeves 2 in the pre-installed state from being axially pulled off or slipping off from the main fitting body 6 counter to the installation direction or joining direction.

FIG. 12 shows two pressing sleeves 2 according to FIG. 10 in an installed state on the main fitting body 6 with two pipe ends 30. The interaction of the pressing sleeve 2, the main fitting body 6 and the pipe end 30 can be understood from the detail.

FIG. 13 shows a fifth exemplary embodiment of a pressing sleeve 2 in a perspective view.

Here, the retaining lug 10 is provided directly on the face side on the receiving section 4, wherein the retaining lug 10 extends over the entire circumference of the pressing sleeve 2. To that end, the periphery of the receiving section 4 is flanged in a curved manner by more than 90° inwards. The pressing sleeve 2, contrary to the exemplary embodiment shown in FIGS. 10 to 12, is in addition formed from a component with different wall thicknesses, in order to strengthen the pressing area 8 in particular.

FIG. 14 shows two pressing sleeves 2 according to FIG. 13 and a main fitting body 6 in a pre-installed state. The retaining lug 10 secures the pressing sleeves 2 in the pre-installed state from being axially pulled off or slipping off from the main fitting body 6 counter to the installation direction or joining direction.

FIG. 15 shows two pressing sleeves 2 according to FIG. 13 in an installed state on the main fitting body 6 with two pipe ends 30. The interaction of the pressing sleeve 2, the main fitting body 6 and the pipe end 30 can be understood from the detail.

FIG. 16 shows a sixth exemplary embodiment of a pressing sleeve 2 in a perspective view. Here, the retaining lugs 10 are formed as elements of a cutting ring 38 separate from the main body of the pressing sleeve 2. A plurality of retaining lugs 10 are provided via the cutting ring 38 along the circumference of the pressing sleeve. The cutting ring 38 and the retaining lugs 10 can be manufactured from a material which is different from the rest of the pressing sleeve.

FIG. 17 shows two pressing sleeves 2 according to FIG. 16 and a main fitting body 6 in a pre-installed state. The cutting ring 38 with the retaining lugs arranged on it is held in a groove 40 in the receiving section 4. The retaining lug 10 secures the pressing sleeves 2 in the pre-installed state on the main fitting body 6.

FIG. 18 shows two pressing sleeves 2 according to FIG. 16 in an installed state on the main fitting body 6 with two pipe ends 30. The interaction of the pressing sleeve 2, the main fitting body 6 and the pipe end 30 can be understood from the detail.

1. A pressing sleeve for a press fitting for producing a sealing, non-releasable pipe connection,
having a receiving section for receiving a main fitting body and having a pressing section,
wherein the inner diameter of the receiving section is adapted to the outer diameter of the main fitting body, and
wherein the inner diameter of the pressing section is at least in sections designed to be smaller than the outer diameter of the main fitting body,
wherein at least one retaining lug which can be clamped resiliently elastically inwards in the radial direction is provided in the receiving section, and
wherein the retaining lug has a free end section which, with the retaining lug in the unclamped state, protrudes in the radial direction at least partially into the interior of the receiving section.

2. The pressing sleeve according to claim 1, wherein the pressing sleeve is produced by forming, in particular by deep drawing.

3. The pressing sleeve according to claim 1, wherein the retaining lug is released through a radial opening provided between an inner lateral surface and an outer lateral surface of the pressing sleeve.

4. The pressing sleeve according to claim 1, wherein the pressing sleeve in the area of the receiving section has a face side provided for inserting the main fitting body, and wherein the retaining lug is inclined in the direction facing away from the face side.

5. The pressing sleeve according to claim 4, wherein a guide surface of the retaining lug facing the face side is arranged inclined at an angle in relation to a central axis of the pressing sleeve, wherein the angle is greater than 0° and less than 90°.

6. The pressing sleeve according to claim 1, wherein a pressing edge provided for abutting on the main fitting body is formed in the area of the free end section of the at least one retaining lug, wherein the pressing edge is in particular sharp-edged.

7. The pressing sleeve according to claim 1, wherein the receiving section has an essentially constant opening width along its length measured in the axial direction.

8. The pressing sleeve according to claim 4, wherein the pressing section extended in the direction facing away from the face side is attached to the receiving section, wherein the inner diameter of the pressing section is tapered in the direction facing away from the face side.

9. The pressing sleeve according to claim 8, wherein an end section extended in the direction facing away from the face side is attached to the pressing section, wherein the pressing sleeve has in particular an essentially constant opening width in the area of the end section.

10. The pressing sleeve according to claim 1, wherein the receiving section on the face side merges into a circularly circumferential flange.

11. The pressing sleeve according to claim 1, wherein two or more, in particular three or more, retaining lugs are provided.

12. The pressing sleeve according to claim 11, wherein the retaining lugs are in particular arranged at regular angular distances in relation to one another.

13. The pressing sleeve according to claim 1, wherein the retaining lugs are formed as separate elements, in particular in the form of a cutting ring.

14. A press fitting for a sealing, non-releasable pipe connection,
having a main fitting body for accommodating at least one pipe to be connected, and
having a pressing sleeve according to claim 1.

15. A use of a pressing sleeve or of a press fitting according to claim 1 in a heating installation, air-conditioning installation, sanitary installation or drinking water installation or in an installation for conveying technical or medical fluids.
